(19) United States
(12) Patent Application Publication
(10) Pub. No.: US 2008/0060101 A1
(43) Pub. Date: Mar. 13, 2008

(54) SPACE SUIT PROTECTIVE OVERCOVER

(76) Inventor: David P. CADOGAN, Middletown, DE (US)

Correspondence Address: STEVENS DAVIS MILLER & MOSHER, LLP, 1615 L STREET, NW, SUITE 850, WASHINGTON, DC, 20036, US

(21) Appl. No.: 11/848,443

(22) Filed: Aug. 31, 2007

Related U.S. Application Data
(60) Provisional application No. 60/841,187, filed on Aug. 31, 2006.

(51) Int. Cl. B64G 6/00

(52) U.S. Cl. 2/2.11

(57) ABSTRACT

A protective cover for a space suit, suitable for use in lunar or Mars visits which provides protection to the space suit against dust and organic contaminants while withstanding the rigors of contact with lunar or Martian rocks and equipment and not degrade or tear. The cover can be easily donned and doffed without contaminating the space suit. High strength coated fabrics which are functional in the thermal extremes of the lunar and Mars environments are suitable materials for the protective covers.

### CROSS REFERENCE TO RELATED APPLICATIONS

This application claims benefit under 35 U.S.C. 119 of Provisional Application Ser. No. 60/841,187 filed Aug. 31, 2006, the entire disclosure of which is herein incorporated by reference.

### FIELD OF THE INVENTION AND BACKGROUND

During project Apollo many issues arose regarding the impact of the lunar soil (dust) on space suits, vehicles and the astronauts. Lunar regolith is a particulate material that ranges in particle size down to the nano-scale and can also be electrostatic in nature. Exposure of this material to machinery can seriously degrade its performance, and exposure to humans can pose significant health threats. Excursions of astronauts to the lunar surface during NASA's Project Apollo led to a situation where the space suits became covered in regolith which was impossible to remove. Subsequently, that material eventually penetrated openings in the suit and compromised rotary bearing and pressure seal performance, and was carried back in the Lunar Excursion Module (LEM) where it caused issues with life support systems and electro-mechanical systems. Upon return to lunar orbit and transit back to earth, all the loose lunar material became airborne in zero-gravity and posed further threat to the crew and vehicle.

NASA is now considering returning to the lunar surface and eventually proceeding to Mars. Longer stays and more rigorous extravehicular activity (EVA) will occur when this is realized, and the dust contamination issues will be compounded for suits, robotics, humans, vehicles, airlocks, and equipment. Dust contamination issues on Mars will potentially be of greater complexity than the moon because of the airborne nature of the particulate, planetary protection issues, especially the environment of the United States, and chemical nature of the dust (strong oxidizer). Planetary protection of Mars will be important in the search for life and the prevention of contaminates from space suits and robotic rovers will need to be kept from reaching the planetary surface, and contaminates from the surface will need to be kept from entering the habitat and return spacecraft to prevent back-contamination of Earth. A new approach has been developed and testing conducted to provide protection from dust contamination. Working off of the paradigm used in chemical protective equipment where the person is protected from the threat during some form of work, a spacesuit protective cover and a use methodology has been developed to enable long term functions on the lunar and Mars surface and eliminate threats to personnel and equipment.

At this time, no methodology has been developed to provide comprehensive dust protection of the space suit on the lunar surface. Some materials development has been conducted by various parties at NASA and in industry to make materials electrostatic in nature to repel dust, but these do not address the system. NASA has developed concepts for a suit-lock where a space suit remains constantly attached to the exterior of the vehicle and the crew enters the suit through a rear hatch. In this approach the dust on the space suit theoretically never is brought into the crew cabin. However, this does not address the protection of the suit itself, or the maintenance of the dirty suit which must occur-in-vehicle. It also assumes the EVA space suit will be a different suit from the suit used for launch and landing, which has a significant impact on overall system mass. The high mass and volume of the inclusion of numerous suit ports also has a pronounced system impact which will make it an unlikely candidate for use in future architectures. A single spacesuit which is extensible in configuration, such as was used in Apollo, will be considerably more effective in achieving performance goals for future exploration systems. The addition of lightweight protective covers which can be packed into very small volumes for transport, will extend spacesuit performance and provide contamination protection during all aspects of the mission (EVA, in-vehicle, and return to Earth).

### SUMMARY OF THE INVENTION

At the core of the invention is a cover that is donned by the suited astronaut prior to excursions into a dust environment, and then doffed prior to reentry of the vehicle. The cover is highly specialized to provide protection from dust while withstanding the rigors of contact with lunar rocks and equipment, and not degrade or tear. It also is designed in such a way that it does not hinder the mobility of the space suit in any way, and can be easily donned and doffed without contaminating the space suit. Therefore, the materials of construction will be high strength coated fabrics which are functional in the thermal extremes of the Lunar and Mars environments. Methods of construction such as gathering, gusseting, and the use of extensible materials and interfaces will be used to maintain conformity to the space suit and at the same time not hinder mobility. The outer cover may be a one piece suit which is donned in a similar fashion as a chemical protective suit, or it may be in multiple garments with overlapping sections. Dust rejection techniques such as electrostatic charging, or lotus effect surface preparations can be included in the cover material to aid in dust shedding to prolong the cover's life. Other functions such as power generation and storage can also be included in the cover, if desirable.

### BRIEF DESCRIPTION OF THE DRAWINGS

FIGS. 1A-1C shows an embodiment of the invention for a protective space suit cover;

FIG. 2 shows another embodiment of the invention where protective covers are placed on portions of a robotic rover apparatus;

FIGS. 3A-3C show other embodiments of the invention for terrestrial containment covers used in pharmaceutical manufacturing environments; and

FIG. 4 shows the anticipated environment where the overcover may be used in lunar or Mars landing scenarios.

### DETAILED DESCRIPTION OF THE PREFERRED EMBODIMENTS

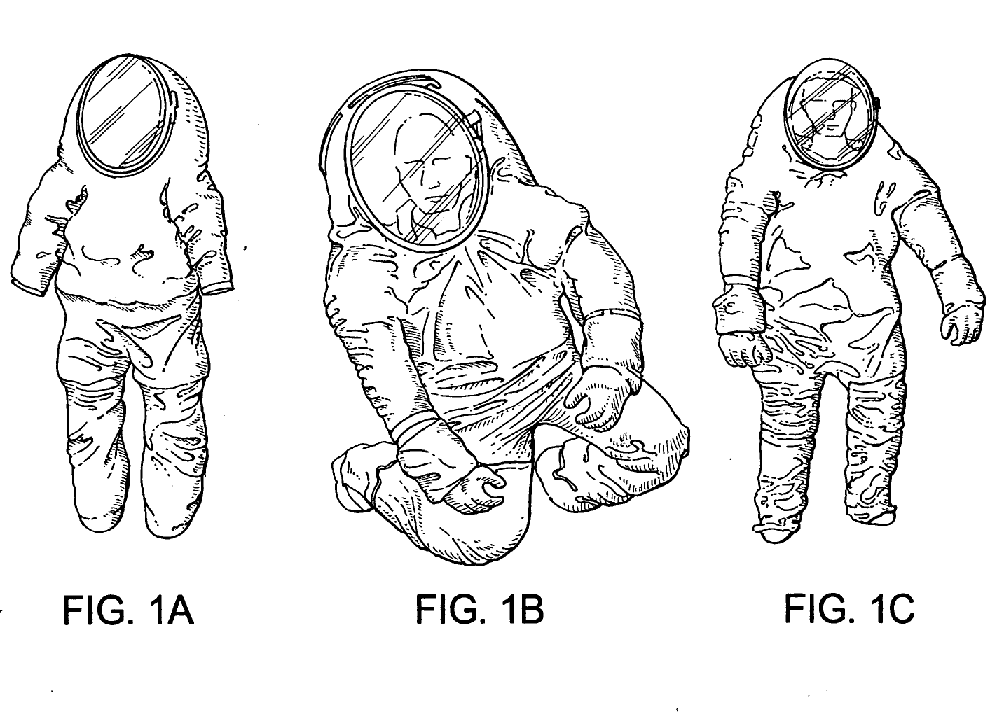

As shown in FIG. 1A is a protective spacesuit cover 10 which can be donned over a suited astronaut 12 (FIG. 1B) in a manner to have mobility when standing (FIG. 1C) or even kneeling (FIG. 1B). The cover 10 can protect against lunar or Martian dust as well as organic contaminants. Typical properties of lunar regolith are as follows:

Data Desorbing the Characteristics of Lunar Surface Dust:

The lunar regolith is chemically composed of several elements and compounds in varying concentrations
Carbon, hydrogen, and nitrogen found in the regolith is almost entirely due to implantation by the solar winds
Unlike most Earth soils, the lunar soil has high concentrations of silicon, iron, calcium, aluminum, magnesium, titanium, manganese, sulphur, and nickel
   Many of these elements are found in oxides such as FeO, MnO, MgO, etc.
   Ilmenite (FeTiO3), most common in the mare regions, is the best source of in-situ oxygen

“Weathering” has left the lunar soil with a relatively fine texture, as illustrated by the grain-size distribution on soil taken from a mare region on Apollo11.

| Grain Size (mm) | % Weight |
|---|---|
| 10-4 | 1.67 |
| 4-2 | 2.39 |
| 2-1 | 3.20 |
| 1-0.5 | 4.01 |
| 0.5-0.25 | 7.72 |
| 0.25-0.15 | 8.23 |
| 0.15-0.090 | 11.51 |
| 0.090-0.075 | 4.01 |
| 0.075-0.045 | 12.40 |
| 0.045-0.020 | 18.02 |
| Less than 0.020 | 26.85 |

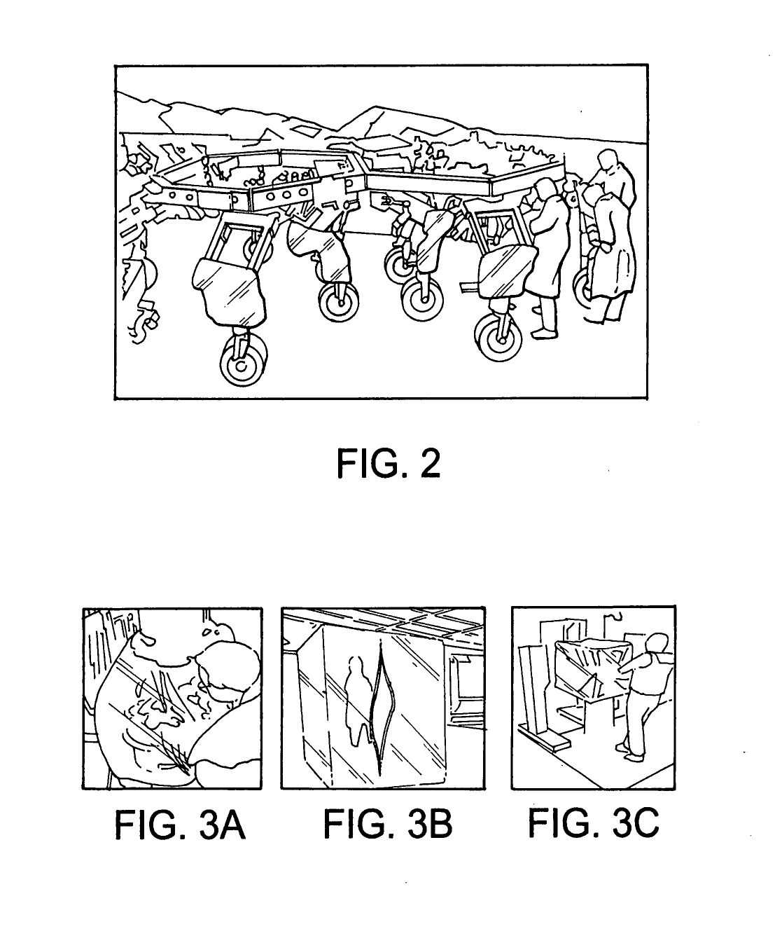

Such contaminants can also affect the equipment used in the lunar or Mars environments, such as the robotic rover apparatus. FIG. 2 shows that the protective covers 20 can also be placed on portions of the robotic rover to prevent dust contamination of the joints of the moving elements.

Although primarily designed for extraterrestrial use, the invention can also be used for terrestrial contaminant covers 30, 31, 32 used in pharmaceutical manufacturing environments as shown in FIGS. 3A-3c.

However, the most preferred use of the protective covers of the invention is for space suit protection.

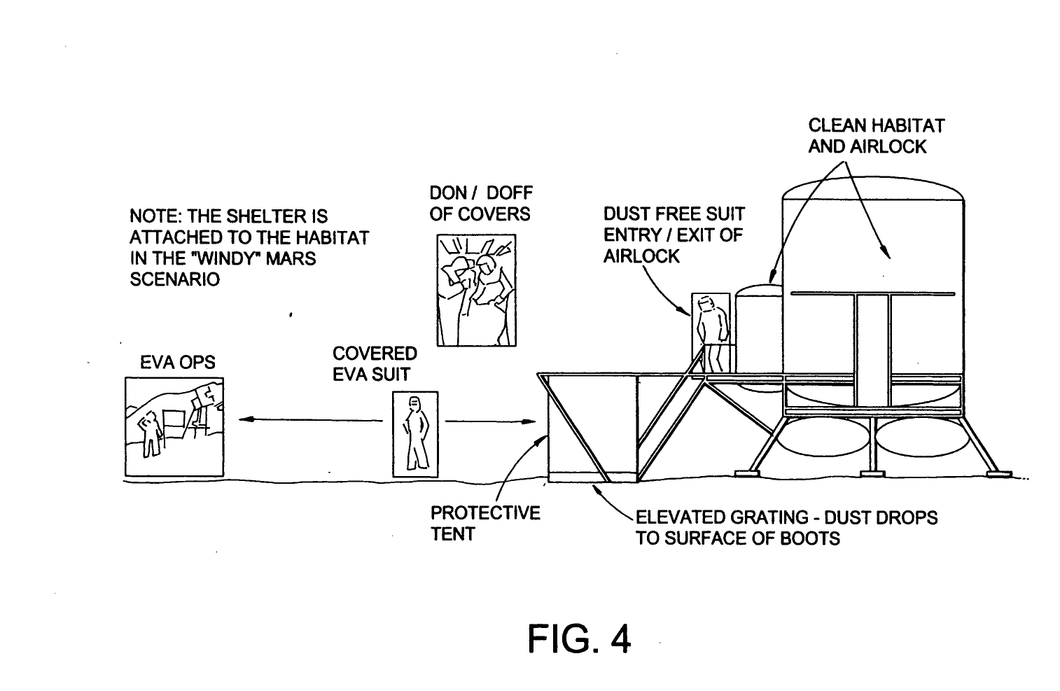

From a use standpoint, the initial donning of the cover over a space suit can be done in the lunar lander prior to the first EVA (when suit and cover are clean). The crew would prepare a simple doffing station at the base of the ladder (basically a trap or a grated floor and a bench). After the lunar or Mars surface EVA the crew would doff the covers on the doffing stations and then traverse back into the lander or long term habitat in a clean spacesuit, thus leaving the majority of contamination outside. See, the scenario shown in FIG. 4. Subsequent EVAs then consist of the clean suited crew traversing from the airlock to the donning station, donning the dust protective covers, and repeating the process. These same processing steps and covers can be used for robotics and other equipment as well as described above in connection with FIG. 2.

The materials used in the construction of the covers 10, 20 are designed such that they provide a contiguous surface to protect against particulate incursion down to the nano-scale, can withstand flex and wear in the specified environments, and be able to be compactly packaged. The material, being on the exterior of the space suit or robotic assembly will also need to possess the proper optical properties to maintain thermal control of the underlying equipment and will preferably be white in color on the exterior. The interior may be white or another color to foster thermal balancing within the suit. The base material of the garment will be in the form of a high strength lightweight coated fabric or laminate of films and fabrics with no localized porosipy, and will preferably include rip-stops to prevent the propagation of a tear if one should occur. The reinforcement and ripstop portion will be a string fiber such as Vectran™, Kevlar™, fiberglass or UHMWPE, but may also be made from FEP or PTFE or similar fibers. The reinforcement may be woven on non-woven in form, and could be electrospun. The matrix or membrane films will be comprised of highly flexible films such as FEP, PTFE, PET, polyamides, polyimides, PBO, polyolefin, polyurethane, or similar materials. The membrane may also consist of commercially available films such as Tyvek™, Gore-Tex™, or others. It is preferable that insulation may be added in various portions or the entire garment and could take the form of metallized films, aerogels, or insulative batting. Elastic materials or specialty weaves may be attached to the garment, be included in the base material, to facilitate attachment to the suit or robot, and assisting with maintaining a conformal fit. Toughened materials such as SuperFabric™ (small ceramic plates on a fabric), Turtleskin™ (densely woven fibers), or others may be applied locally to areas such as the knees or elbows, or other areas likely to experience wear to locally increase durability. A clear polycarbonate or optically clear film visor cover (hat assembly) can also be included in the cover to provide protection to the helmet. The inclusion of electronic materials to provide embedded functionality such as switches, power generation and storage, heating, lighting, etc., are also possible. Self-healing materials may also be included in the cover garment 10 to ensure its long term durability and performance. These materials seal small penetrations through the inclusion of embedded functions such as a viscoelastic response, microencapsulated foaming material response, or a strain energy response. The materials of the suit cover 10 may also be selected such that they aid in the protection of the astronaut 12 from radiation through the use of high content hydrogen materials such as polyethylene or hydrogen laden carbon nano-tubes mixed into various matrix materials. Protection in the form of IR reflection, UV reflection or absorption and adsorption of high energy particles are preferred properties of the protective overcover.

The garment 10 can be assembled by cutting and joining patterned materials. Thermal sealing, bonding, or sewing and adding cover tapes are the preferred methods of assembly. The garments 10 may be single components which in the case of the space suit resemble a full body suit, or they may be in multiple overlapping or joined components which resemble a coat, pants, hat assembly and boots. Space suit cover garments 10 may have integral gloves or boots which have all the durability required, or may have integral thin cover gloves or boots which mate with externally applied highly durable garments. The garments will include facilities for simplifying donning and doffing without contaminating the space suit or underlying components. This will include the ability to be turned inside out, attach to devices which aid donning/doffing, retractable cover flaps, and secondary covers which trap the dirty surfaces between layers during donning and doffing. Devices to aid donning/doffing include zippers, hook and loop fasteners, such as Velcro™, snaps, elastics, internal coatings, inflatable components overflaps, stands and hardware.

It will be apparent that the invention can be modified from the description of the preferred embodiments of the invention which are to be taken only as exemplary, but not limiting, examples of the invention. It will be appreciated that the invention can be utilized to promote planetary protection by avoiding and/or limiting the amount of extraterrestrial dust and/or organic contaminants on a space suit or robotic assembly or spacecraft containing the same returning to Earth.

We claim:

1. A lightweight highly mobile protective overcover which protects a space suit, robot, or component from extraterrestrial contaminates such as dust or chemicals, and is removable external to a spacecraft or habitat to leave contaminates external to the spacecraft or habitat.

2. The cover of claim 1, which incorporates at least one selected from the groups consisting of zippers, hook and loop fasteners, snaps, elastics, internal coatings, inflatable components, overflaps, stands and hardware, which make it easily donnable and doffable while wearing a pressurized space suit.

3. The cover of claim 1, which incorporates materials and patches to prevent puncture, tear and abrasion to enhance the life of the protective cover.

4. The cover of claim 1, which is comprised of a single piece assembly to cover the entire space suit.

5. The cover of claim 1, which has integral or externally applied specialized components for enhanced environmental interface on a planetary surface or in zero-gravity.

6. The cover of claim 1, which is manufactured from a base that is a coated fabric or a laminate of films and fabrics and provides a contiguous barrier around the wearer with no localized porosity.

7. The cover of claim 1, which is manufactured from a base material that provides radiation protection to the space suit in the form of IR reflection, UV reflection or absorption, and absorption of high energy particles.

8. The cover of claim 1, which incorporates elastic fibers or films or extensible inelastic materials in the form of specialized knits or weave styles and elastic coatings, in the base material or as internal straps/webbings, which maintain conformity of the cover to the space suit without degrading mobility, and also facilitate fitting a large population with very few sized garments.

9. The cover of claim 1, which incorporates dust rejection technologies or materials enhancements to promote dust rejection.

10. The cover of claim 1, which incorporates anti-microbial coatings and filters to reduce or eliminate surface contamination by the space suit or robot assembly to promote environment of the United States.

11. The cover of claim 1, with embedded electronic materials and functions for heating, power generation and storage, RF communications, switches, lighting, computer interface, and structural health monitoring.

12. The cover of claim 1, with embedded self-healing materials which heal any damage to the cover and maintain its barrier properties after a cut or penetration.

13. The cover of claim 1, which may include a secondary cover garment to trap the dust on the exterior of the cover garment and allow donning/doffing without concern of contamination of the suit.

14. The cover of claim 1, which can also be used in a spacecraft over a contaminated space suit to act as a containment system and prevent subsequent release of particulate inside the spacecraft.

15. A cover garment according to claim 1, which can be worn by the crew internal to the spacecraft to aide in crew performance or protection.

16. The cover of claim 1, which is in multiple components selected from at least one of the group consisting of trouser, jacket, boot, glove, and hat.

17. The cover of claim 9, wherein the dust rejection technology or materials enhancements to promote dust rejection include at least one selected from the consisting of electrostatic coatings, electrostatic assemblies, super hydrophobic surface preparations and vibration devices.

18. The method of claim 10, wherein the planetary protection is achieved by reduction or elimination of the deposition of organic material on the surface of a space suit.

19. The cover of claim 3, wherein the materials and patches are used in the areas of the knees and elbows.

20. The cover of claim 5, wherein the specialized components comprise at least one selected from the group consisting of overboots, cover gloves and visor assemblies.
